(19) United States
(12) Patent Application Publication
(10) Pub. No.: US 2017/0331139 A1
(43) Pub. Date: Nov. 16, 2017

(54) FUEL CELL SYSTEM

(71) Applicant: DELPHI TECHNOLOGIES, INC., Troy, MI (US)

(72) Inventors: RICK D. KERR, FENTON, MI (US); MICHAEL J. SEINO, FLUSHING, MI (US); THOMAS F. MCQUAIG, LEROY, NY (US); CHRISTOPHER M MIENEY, ROCHESTER, NY (US); ADAM G. WRIGHT, ROCHESTER, NY (US); DANIEL E. PERRIN, CANANDAIGUA, NY (US)

(21) Appl. No.: 15/155,582

(22) Filed: May 16, 2016

(51) Int. Cl. H01M 8/2485; H01M 8/247; H01M 8/2465; H01M 8/249; H01M 8/241

(52) U.S. Cl. CPC H01M 8/2485; H01M 8/249; H01M 8/241; H01M 8/2465; H01M 8/247

(57) ABSTRACT

A fuel cell system is provided with a fuel cell stack assembly which includes a plurality of fuel cells which convert chemical energy from a fuel into electricity through a chemical reaction with an oxidizing agent, the plurality of fuel cells being stacked together in electrical series; a base member upon which the plurality of fuel cells are stacked such that the base member is in electrical communication with the plurality of fuel cells; an attachment member fixed to the base member, the attachment member being maintained at electrical ground; and a dielectric barrier which electrically isolates the base member from the attachment member.

This invention was made with government support under Contract No. DE-FE-0011769 awarded by the United States Department of Energy. The government has certain rights in this invention.

### TECHNICAL FIELD OF INVENTION

The present invention relates to a fuel cell system with a stack of fuel cells which convert chemical energy from fuel into electricity through a chemical reaction with an oxidizing agent and more particularly to an arrangement which isolates the fuel cell stack from electrical ground.

### BACKGROUND OF INVENTION

Fuel cells are devices which convert chemical energy from a fuel into electricity through a chemical reaction with an oxidizing agent, commonly air, where the fuel passes over an anode and the oxidizing agent passes over a cathode which is separated from the anode by an ion conducting electrolyte. Individual fuel cells typically produce a relatively small electrical potential, for example, typically about 1 volt or less. Consequently, several fuel cells are stacked together in electrical series, in the form of fuel cell cassettes, in order to form a fuel cell stack which produces a potential difference that is equal to the sum of the potential differences of each individual fuel cell. In order to deliver electric current produced by the fuel cell stack to an electrical load, the anode or cathode of the first fuel cell cassette of the fuel cell stack is placed in electrical communication with a lower current collector while the anode or cathode—whichever is opposite from that in contact with the lower current collector—of the last fuel cell cassette of the fuel cell stack is placed in electrical communication with an upper current collector. The lower current collector can then be electrically connected to a first terminal of an electrical load while the upper current collector can be electrically connected to a second terminal of the electrical load which is opposite polarity from the first terminal, thereby completing an electrical circuit.

The fuel cell stack may define 1) fuel supply passages which communicate fuel to each anode, 2) oxidizing agent supply passages which supply oxidizing agent to each cathode, 3) anode exhaust passages which remove excess and depleted fuel (anode exhaust) from each anode, and 4) cathode exhaust passages which remove excess and depleted oxidizing (cathode exhaust) agent from each cathode. Consequently, adjacent fuel cell cassettes of the fuel cell stack must be sealed in order to prevent leakage from the supply and exhaust passages. Furthermore, the fuel cell stack may be placed on a fuel cell manifold which supplies fuel to the fuel supply passages, supplies oxidizing agent to the oxidizing agent supply passages, collects excess and depleted fuel from the anode exhaust passages, and collects excess and depleted oxidizing agent from the cathode exhaust passages. In addition to preventing leakage from the supply and exhaust passages between adjacent fuel cells, it is necessary to electrically insulate the anodes of adjacent fuel cell cassettes and also insulate the cathodes of adjacent fuel cell cassettes in order to prevent a short circuit from occurring. Consequently, seals that prevent leakage from the supply and exhaust passages are typically glass-ceramic seals which are capable of withstanding the high operating temperature, i.e. 700° C. to 900° C., of the fuel cells. The fuel cell stack is held in compression between an end cap and the fuel cell manifold by tie rods, thereby maintaining the glass-ceramic seals in compression during operation.

In one known arrangement as shown in FIG. 1, a fuel cell stack 10 is comprised of fuel cell cassettes 12₁ through 12ₙ where fuel cell cassette 12₁ is the first fuel cell cassette and fuel cell cassette 12ₙ is the last fuel cell cassette. First fuel cell cassette 12₁ of fuel cell stack 10 is in electrical contact with a lower current collector 14 and last fuel cell cassette 12ₙ of fuel cell stack 10 is in electrical contact with an upper current collector 16. Fuel cell stack 10, lower current collector 14, and upper current collector 16 are held in compression between a fuel cell manifold 18 and an end cap 20 by tie rods 21 such that fuel cell manifold 18 and end cap 20 are electrically isolated from lower current collector 14 and upper current collector 16. In order to electrically isolate fuel cell manifold 18 from fuel cell stack 10, a glass-ceramic seal 22 is provided between lower current collector 14 and fuel cell manifold 18 because glass-ceramic seal 22 must also seal gases that are passing between fuel cell manifold 18 and fuel cell stack 10. In order to electrically isolate end cap 20 from fuel cell stack 10, a mica sheet 24 is provided between upper current collector and end cap 20. In this way, fuel cell manifold 18 and end cap 20 are maintained at electrical ground.

In order to further increase the magnitude of electrical potential produced, several fuel stacks 10 may be connected electrically in series as shown in FIG. 1 to produce a fuel cell system 26. More specifically, upper current collector 16 corresponding to each fuel cells stack 10 is electrically connected to lower current collector 14 corresponding to the next fuel cell stack 10 in the series of fuel cell stacks 10 while lower current collector 14 corresponding to the first fuel cell stack 10 in the series is connected to one side of an electric load 28 and upper current collector 16 corresponding to the last fuel cell stack 10 in the series is connected to the other side of electric load 28. Fuel cell manifold 18 of each fuel cell stack 10 may be connected to a system manifold 30 which supplies fuel and oxidizing agent to each fuel cell manifold 18 and which removes excess and depleted fuel and excess and depleted oxidizing agent from each fuel cell manifold 18. System manifold 30 is maintained at electrical ground just as with fuel cell manifolds 18, so there is no need to electrically isolate system manifold 30 from fuel cell manifolds 18. In this way, sealing between fuel cell manifolds 18 and system manifold 30 may be easily accomplished through brazing or welding.

Since fuel stacks 10 are connected electrically in series, the potential difference between lower current collector 16 and fuel cell manifold 18 is the sum of the potential differences produced by each previous fuel cell stack 10. As an example, if each fuel cell stack 10 produces a potential difference of 50 volts, then the potential difference between lower current collector 14 and fuel cell manifold 18 of the fourth fuel cell stack 10 in the series will be 150 volts. Also consequently, the potential difference between upper current collector 16 and end cap 20 is the sum of the potential difference produced by each previous fuel cell stack 10. As an example, if each fuel cell stack 10 produces a potential difference of 50 volts, then the potential difference between upper current collector 16 and end cap 20 of the fourth fuel cell stack 10 in the series will be 200 volts because the potential difference produced by fuel cell stack 10 in the fourth fuel cell stack 10 in the series contributes to the potential difference between upper current collector 16 and end cap 20 of the fourth fuel cell stack 10. Since mica sheet 24 only needs to provide electrical isolation between upper current collector 16 and end cap 20 (no gas sealing), mica sheet 24 can be easily designed to accommodate the potential difference that will be experienced. However glass-ceramic seal 22 must also seal against gas under pressure, adhere to lower current collector 14 and fuel cell manifold 18, and match the coefficient of thermal expansion of lower current collector 14 and fuel cell manifold 18 while simultaneously providing sufficient dielectric strength to accommodate the potential difference that will be experienced. It is this combination of properties that makes glass-ceramic seal 22 challenging to implement.

What is needed is a fuel cell system which minimizes or eliminates one of more of the shortcomings as set forth above.

### SUMMARY OF THE INVENTION

A fuel cell system is provided with a fuel cell stack assembly which includes a plurality of fuel cells which convert chemical energy from a fuel into electricity through a chemical reaction with an oxidizing agent, the plurality of fuel cells being stacked together in electrical series; a base member upon which the plurality of fuel cells are stacked such that the base member is in electrical communication with the plurality of fuel cells; an attachment member fixed to the base member, the attachment member being maintained at electrical ground; and a dielectric barrier which electrically isolates the base member from the attachment member.

### BRIEF DESCRIPTION OF DRAWINGS

This invention will be further described with reference to the accompanying drawings in which:

FIG. 1 is a schematic representation of a prior art fuel cell system;

FIG. 2 is a schematic representation of a fuel cell system in accordance with the present invention;

FIG. 3 is an exploded isometric view of a fuel cell stack of the fuel cell system in accordance with the present invention;

FIG. 4 is a schematic view of a fuel cell of the fuel cell system in accordance with the present invention;

FIG. 5 is an isometric view of the fuel cell stack of FIG. 3;

FIG. 6 is an isometric view of a fuel cell stack assembly of the fuel cell system in accordance with the present invention;

FIG. 7 is a cross-sectional view of a portion of the fuel cell system in accordance with the present invention; and

FIG. 8 is a cross-sectional view of another portion of the fuel cell system in accordance with the present invention.

### DETAILED DESCRIPTION OF INVENTION

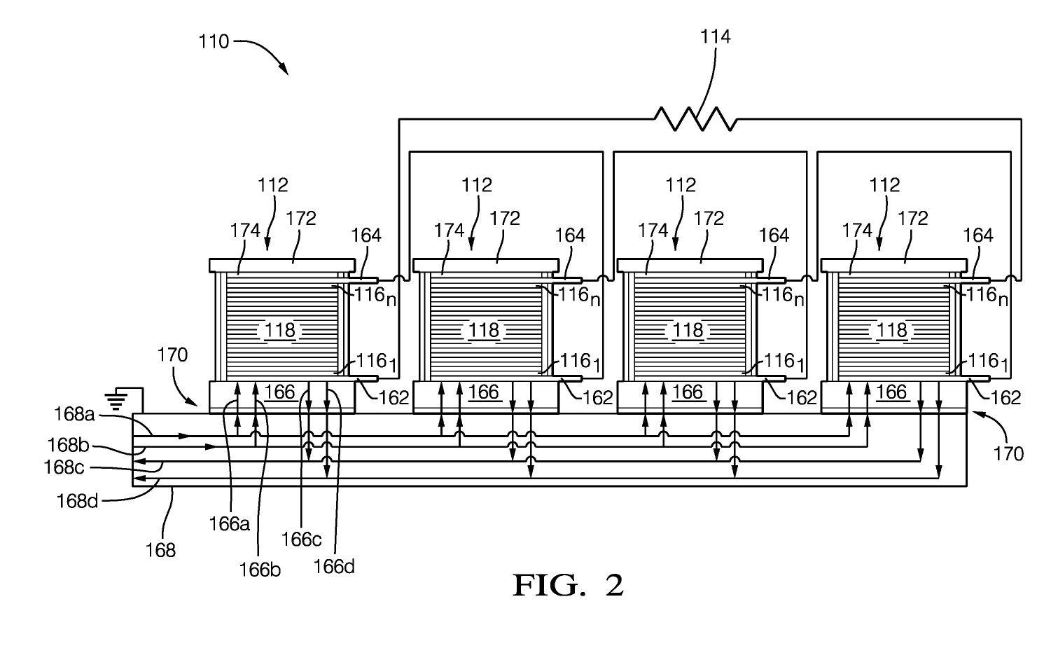

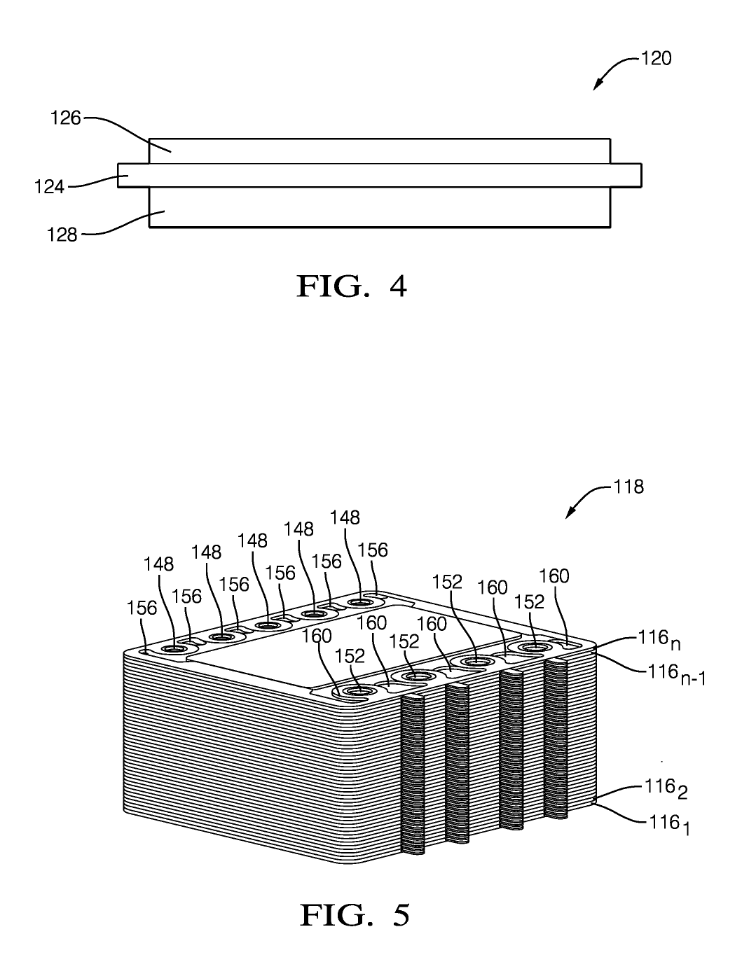

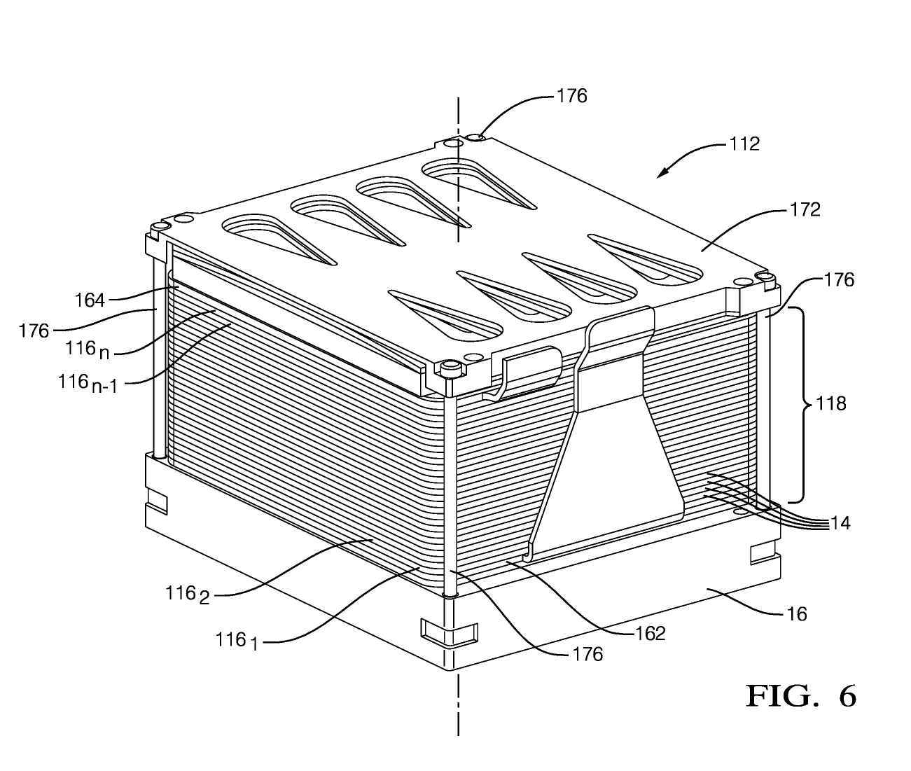

Referring now to FIGS. 2-7 wherein like reference numerals are used to identify identical components in the various views, a fuel cell system 110 is shown in accordance with the present invention. Fuel cell system 110 may include a plurality of fuel cell stack assemblies 112 which produce electricity through a chemical reaction between a fuel and an oxidizing agent. The fuel may be, for example, a hydrogen-rich reformate supplied by a fuel reformer (not shown), and the oxidizing agent may be air. Fuel cell stack assemblies 112 are connected together in electrical series in order to supply a useful potential difference and electric current to an electric load 114. While four fuel cell stack assemblies 112 have been illustrated in the figures, it should now be understood that a lesser or a greater number of fuel cell stack assemblies 112 may be utilized, including as few as one fuel cell stack assembly 112.

Each fuel cell stack assembly 112 includes a plurality of fuel cell cassettes 116₁, 116₂ , . . . 116ₙ₋₁, 116ₙ where n is the number of fuel cell cassettes in a fuel cell stack 118 of fuel cell stack assembly 112. Unless reference is being made to a specific fuel cell cassette, each of the fuel cell cassettes will be referred to generically as fuel cell cassette 116 from this point forward. Fuel cell cassettes 116 include a fuel cell 120 mounted within a retainer frame 122. Fuel cell 120 includes an electrolyte layer 124 sandwiched between a cathode layer 126 and an anode layer 128. Retainer frame 122 defines a central retainer frame opening 130. Fuel cell 120 is positioned in central retainer frame opening 130 and joined to retainer frame 122 to form a cell-retainer frame assembly 132. An intermediate process joins together cell-retainer frame assembly 132, anode spacers 134, an anode interconnect 136, a cathode interconnect 138, and a separator plate 140 to form the complete fuel cell cassette 116. Fuel cell cassette 116 includes sealing surfaces 142 which are complementary to sealing surfaces 142 of the adjacent fuel cell cassette 116 to which it is joined. During assembly of fuel cell stack 118, a glass-ceramic seal 144 is disposed between sealing surfaces 142 of adjacent fuel cell cassettes 116. Glass-ceramic seal 144 forms a bonded joint to provide a gas tight seal to separate and contain reactants and electrically isolate adjacent separator plates 140.

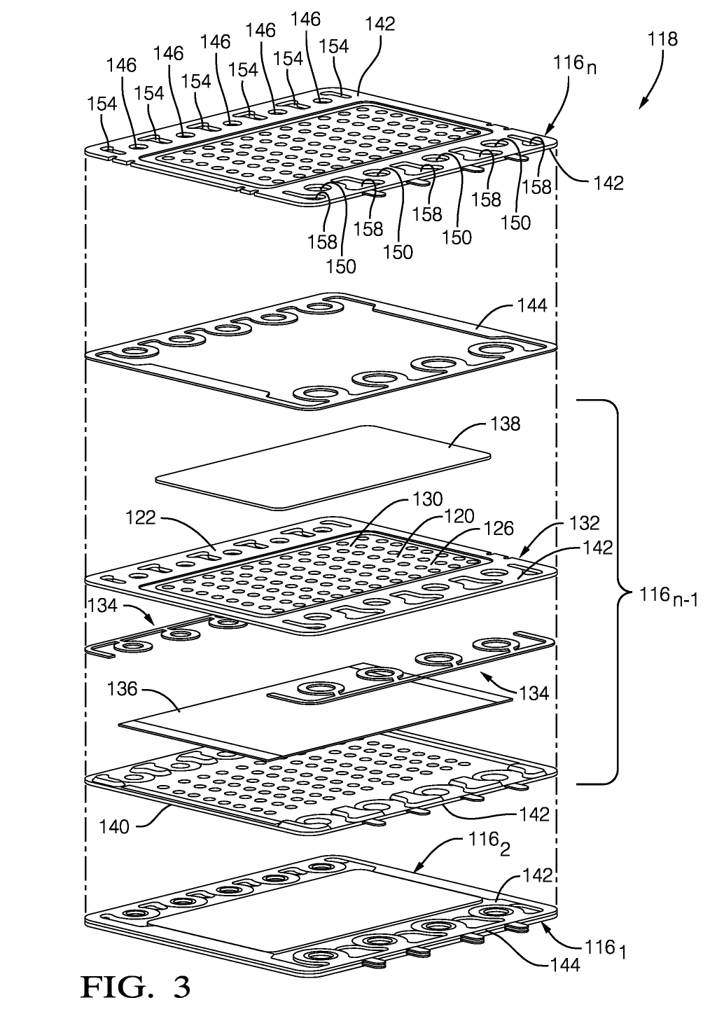

Fuel cell cassette 116 includes a plurality of anode supply passages 146 (for clarity, anode supply passages 146 have only been labeled on fuel cell cassette 116ₙ in FIG. 3). Anode supply passages 146 are formed along one side of fuel cell cassette 116 between fuel cell 120 and the outside edge of fuel cell cassette 116. When fuel cell cassettes 116₁, through 116ₙ are assembled together to form fuel cell stack 118, anode supply passages 146 of each fuel cell cassette 116 are aligned with anode supply passages 146 of adjacent fuel cell cassettes 116 to form a plurality of anode supply chimneys 148. Fuel supplied at one end of fuel cell stack 118 to anode supply chimneys 148 is communicated through anode supply chimneys 148, thereby distributing fuel to each anode layer 128. Anode supply passages 146 for each fuel cell cassette 116 may be formed at regular intervals along the length of fuel cell cassette 116 to distribute fuel evenly across anode layer 128.

Fuel cell cassette 12 also includes a plurality of anode exhaust passages 150 (for clarity, anode exhaust passages 150 have only been labeled on fuel cell cassette 116ₙ in FIG. 3). Anode exhaust passages 150 are formed along the side of fuel cell cassette 116 which is opposite to the side with anode supply passages 146. Anode exhaust passages 150 are disposed between fuel cell 120 and the outside edge of fuel cell cassette 116. When fuel cell cassettes 116₁ through 116ₙ are assembled together to form fuel cell stack 118, anode exhaust passages 150 of each fuel cell cassette 116 are aligned with anode exhaust passages 150 of adjacent fuel cell cassettes 116 to form a plurality of anode exhaust chimneys 152. Anode exhaust chimneys 152 allow anode exhaust from each fuel cell cassette 116 to be communicated to one end of fuel cell stack 118. Anode exhaust passages 150 for each fuel cell cassette 116 may be formed at regular intervals along the length of fuel cell cassette 116 in the same way as anode supply passages 146.

Fuel cell cassette 116 also includes a plurality of cathode supply passages 154 formed along the same side of fuel cell cassette 116 as anode supply passages 146 (for clarity, cathode supply passages 154 have only been labeled on fuel cell cassette 116ₙ in FIG. 3). When fuel cell cassettes 116₁ through 116ₙ are assembled together to form fuel cell stack 118, cathode supply passages 154 of each fuel cell cassette 116 are aligned with cathode supply passages 154 of adjacent fuel cell cassettes 116 to form a plurality of cathode supply chimneys 156. An oxidant, for example air, supplied at one end of fuel cell stack 118 to cathode supply chimneys 156 is communicated through cathode supply chimneys 156, thereby distributing air to each cathode layer 126. Cathode supply passages 154 may be formed at regular intervals along the length of fuel cell cassette 116 to distribute air evenly across cathode layer 126 such that cathode supply passages 154 and anode supply passages 146 are arranged in an alternating pattern along the length of fuel cell cassette 116.

Fuel cell cassette 116 also includes a plurality of cathode exhaust passages 158 formed along the same side of fuel cell cassette 116 as anode exhaust passages 150 (for clarity, cathode exhaust passages 158 have only been labeled on fuel cell cassette 116₁ in FIG. 3). When fuel cell cassettes 116₁ through 116ₙ are assembled together to form fuel cell stack 118, cathode exhaust passages 158 of each fuel cell cassette 116 are aligned with cathode exhaust passages 158 of adjacent fuel cell cassettes 116 to form a plurality of cathode exhaust chimneys 160. Cathode exhaust chimneys 160 allow cathode exhaust from each fuel cell cassette 116 to be communicated to one end of fuel cell stack 118. Cathode exhaust passages 158 for each fuel cell cassette 116 may be formed at regular intervals along the length of fuel cell cassette 116 in the same way as cathode supply passages 154 such that such that cathode exhaust passages 158 and anode exhaust passages 150 are arranged in an alternating pattern along the length of fuel cell cassette 116.

Each fuel cell stack assembly 112 also includes a lower current collector 162 and an upper current collector 164 such that lower current collector 162 is placed in electrical communication with anode layer 128 of fuel cell cassette 116₁ and such that upper current collector 164 is placed in electrical communication with cathode layer 126 of fuel cell cassette 116ₙ. Lower current collector 162 includes passages therethrough which are extensions of anode supply chimneys 148, anode exhaust chimneys 152, cathode supply chimneys 156, and cathode exhaust chimneys 160, thereby allowing gases to flow to and from fuel cell stack 118 as will be described in greater detail later. Lower current collector 162 is sealed to fuel cell cassette 116₁, for example, by brazing or welding, thereby preventing intermixing of gases from anode supply chimneys 148, anode exhaust chimneys 152, cathode supply chimneys 156, and cathode exhaust chimneys 160. Upper current collector 164, unlike lower current collector 162, blocks anode supply chimneys 148, anode exhaust chimneys 152, cathode supply chimneys 156, and cathode exhaust chimneys 160. Upper current collector 164 is sealed to fuel cell cassette 116ₙ, for example, by glass-ceramic sealing, thereby containing the gases within anode supply chimneys 148, anode exhaust chimneys 152, cathode supply chimneys 156, and cathode exhaust chimneys 160.

Lower current collector 162 is captured between fuel cell cassette 116₁ and a fuel cell manifold 166 of fuel cell stack assembly 112 such that fuel cell manifold 166 is in electrical communication with lower current collector 162 and such that fuel cell manifold 166 is maintained at the same electrical potential as fuel cell cassette 116₁. Fuel cell manifold 166 acts as a structural base upon which fuel cell stack 118 is stacked and each fuel cell manifold 166 may receive fuel and air from a system manifold 168 for distribution to anode supply chimneys 148 and cathode supply chimneys 156 and each fuel cell manifold 166 may collect and communicate anode and cathode exhaust to system manifold 168 from anode exhaust chimneys 152 and cathode exhaust chimneys 160. Fuel cell manifold 166 includes 1) a fuel cell manifold anode supply passage 166a which receives fuel from system manifold 168 and distributes fuel to anode supply chimneys 148, 2) a fuel cell cathode supply passage 166b which receives oxidizing agent from system manifold 168 and distributes oxidizing agent to cathode supply chimneys 156, 3) a fuel cell anode exhaust passage 166c which collects anode exhaust from anode exhaust chimneys 152 and communicates anode exhaust to system manifold 168, and 4) a fuel cell cathode exhaust passage 166d which collects cathode exhaust from cathode exhaust chimneys 160 and communicates cathode exhaust to system manifold 168. System manifold 168 includes 1) a system manifold anode supply passage 168a which delivers fuel to each fuel cell manifold 166 for distribution to anode supply chimneys 148, 2) a system manifold cathode supply passage 168b which delivers air to each fuel cell manifold 166 for distribution to cathode supply chimneys 156, 3) a system manifold anode exhaust passage 168c which removes anode exhaust from each fuel cell manifold 166 that is collected from anode exhaust chimneys 152, and 4) a system manifold cathode exhaust passage 168d which removes cathode exhaust from each fuel cell manifold 166 that is collected from cathode exhaust chimneys 160. A dielectric barrier 170 is provided between each fuel cell manifold 166 and system manifold 168 in order to electrically isolate fuel cell manifolds 166 from system manifold 168 which is maintained at electrical ground. Dielectric barrier 170 will be described later in greater detail.

Upper current collector 164 is captured between fuel cell cassette 116ₙ and an end cap 172 of fuel cell stack assembly 112 such that end cap 172 is electrically isolated from upper current collector 164 by a first dielectric member 174, for example a mica sheet, which is disposed between upper current collector 164 and end cap 172. Lower current collector 162, fuel cell stack 118, upper current collector 164, and first dielectric member 174 are held in compression between fuel cell manifold 166 and end cap 172 by tie rods 176 which threadably engage either fuel cell manifold 166 or end cap 172. Tie rods 176 also place fuel cell manifold 166 in electrical communication with end cap 172, thereby maintaining fuel cell manifold 166 and end cap 172 at the same electrical potential which is the same electrical potential as lower current collector 162. In this way, the potential difference between upper current collector 164 and end cap 172 of each fuel cell stack assembly 112 is the voltage produced by the respective fuel cell stack 118. As an example, if each fuel cell stack 118 produces a potential difference of 50 volts, then the potential difference between each upper current collector 164 and its respective end cap 172 is 50 volts.

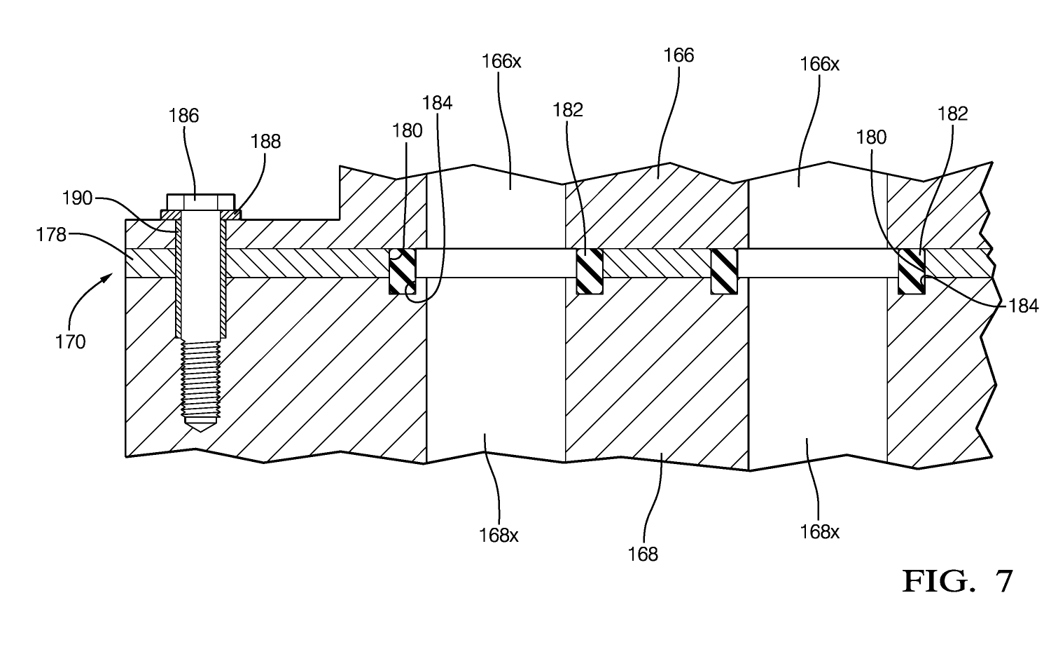

Dielectric barrier 170 will now be described in greater detail with particular reference to FIG. 7. Dielectric barrier 170 includes a second dielectric member 178 which is disposed between fuel cell manifold 166 and system manifold 168 such that second dielectric member 178 spaces fuel cell manifold 166 from system manifold 168. As used herein, second dielectric member 178 spacing fuel cell manifold 166 from system manifold 168 signifies that second dielectric member 178 provides structure which actively maintains separation between fuel cell manifold 166 from system manifold 168 such that in the absence of second dielectric member 178, there is no structure to maintain separation of fuel cell manifold 166 and system manifold 168. Second dielectric member 178 may be, by way of non-limiting example only, a mica sheet. Second dielectric member 178 includes dielectric passages 180 extending therethrough which allow gasses to pass between fuel cell manifold 166 and system manifold 168, i.e. system manifold anode supply passage 168a, system manifold cathode supply passage 168b, system manifold anode exhaust passage 168c, and system manifold cathode exhaust passage 168d. It should be noted that passages 168a, 168b, 168c, 168d are represented generically in FIG. 7 by reference character 168x since the passages in FIG. 7 could represent any of passages 168a, 168b, 168c, 168d. It should also be noted that passages 166a, 166b, 166c, 166d are represented generically in FIG. 7 by reference character 166x since the passages in FIG. 7 could represent any of passages 166a, 166b, 166c, 166d. In order to prevent leakage of gasses, a seal 182 may be located within each dielectric passage 180 such that seal 182 is held in compression between fuel cell manifold 166 and system manifold 168. Seal 182 is preferably annular in shape. System manifold 168 may include seal grooves 184 which are annular in shape which receive a portion of a respective seal 182 therewithin, thereby positively positioning seals 182. Alternatively, or in addition to, seal grooves 184 may be provided in fuel cell manifold 166. Seal 182 may be made from a solid gasket material, and may include, by way of non-limiting example only, talc, fiber, and a binder which is conducive of use in the high operating temperature environment and compatible with the gases to which seal 182 will be exposed. Seal 182 is also electrically insulative in order to prevent electrical communication between fuel cell manifold 166 and system manifold 168 through seal 182. In this way, seal 182 provides a gas-tight seal between fuel cell manifold 166 and system manifold 168 while maintaining electrical isolation.

Fasteners may be used to secure fuel cell manifold 166 to system manifold 168. The fasteners may be, by way of non-limiting example only, bolts which pass through fuel cell manifold 166 and threadably engage system manifold 168. As shown in FIG. 7, a bolt 186 passes through fuel cell manifold 166 and threadably engages system manifold 168, thereby clamping fuel cell manifold 166 between the head of bolt 186 and system manifold 168 in a clamping direction which is in the direction of the length of bolt 186. Alternatively, bolt 186 may pass through system manifold 168 and threadably engage fuel cell manifold 166. Also alternatively, bolt 186 may also pass through system manifold 168 and threadably engage a nut such that fuel cell manifold 166, second dielectric member 178, and system manifold 168 are clamped between the head of bolt 186 and the nut. In order to prevent bolt 186 from providing an electrically conductive path from fuel cell manifold 166 to system manifold 168, dielectric barrier 170 also includes an insulating washer 188 which is disposed between the head of bolt 186 and fuel cell manifold 166 such that insulating washer 188 is positioned between bolt 186 and fuel cell manifold 166 in the clamping direction. By way of non-limiting example only, insulating washer 188 may be made of mica. Dielectric barrier 170 may also include an insulating sleeve 190 which radially surrounds a portion of bolt 186 and prevents bolt 186 from coming into contact with fuel cell manifold 166 such that insulating sleeve 190 is located between bolt 186 and fuel cell manifold 166 in a direction perpendicular to the clamping direction. By way of non-limiting example only, insulating sleeve 190 may be an insulating ceramic material.

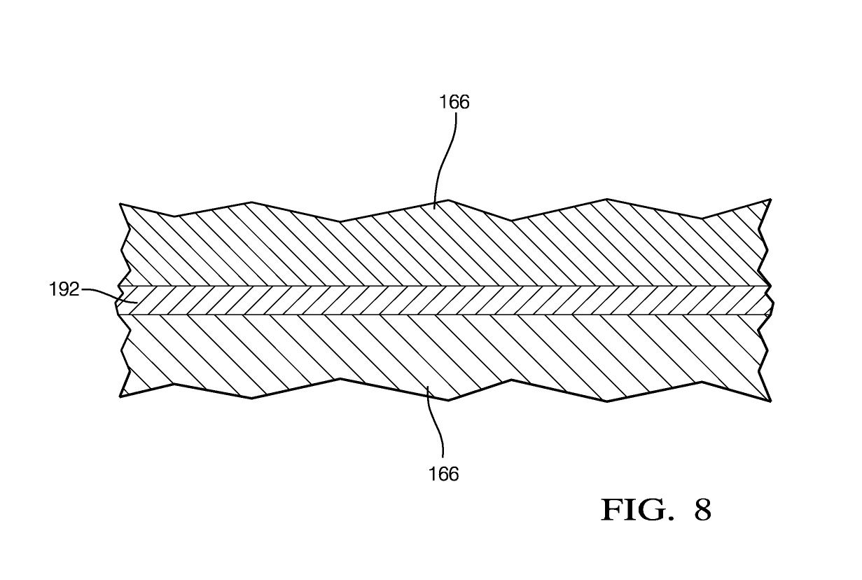

In some circumstances, it may be desirable to attach fuel cell manifolds 166 from two or more fuel cell stack assemblies 112 to each other. However, since each fuel cell manifold 166 is at a unique potential difference, it is necessary to provide electrical isolation between fuel cell manifolds 166 that are attached together. As shown in FIG. 8, fuel cell manifolds 166 are separated by a third dielectric member 192 of dielectric barrier 170, which may be, by way of non-limiting example only, a mica sheet. While not shown, fuel cell manifolds 166 may be attached to each other by a fastener arrangement as shown in FIG. 7, including insulating washer 188 and insulating sleeve 190, and if passages exist for passing gasses between fuel cell manifolds 166, seals 182 may also be included in order to seal gases between fuel cell manifolds 166.

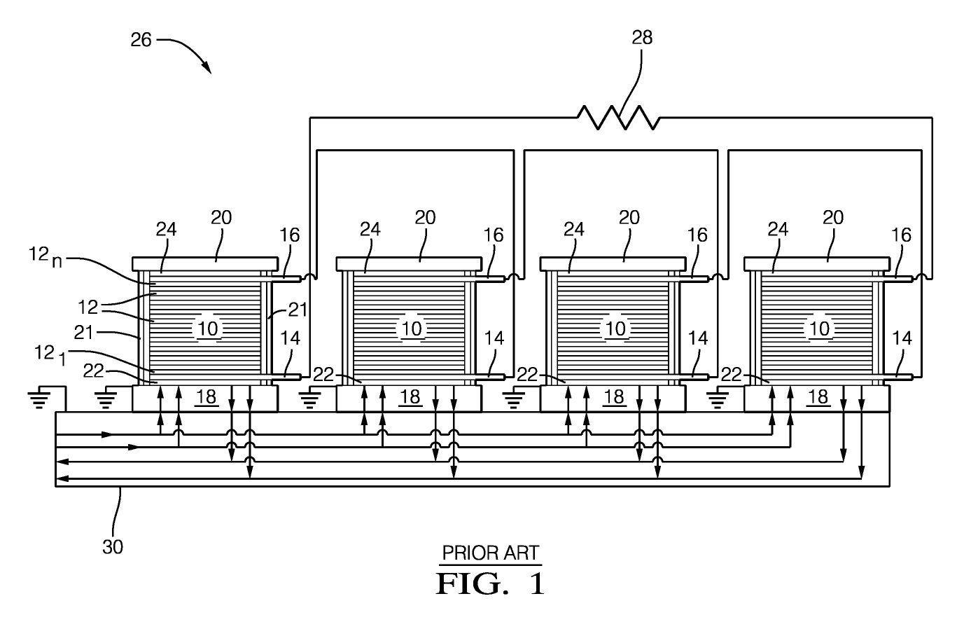

By utilizing dielectric barrier 170, a simplified seal can be formed between lower current collector 162 and fuel cell manifold 166 since there is no longer a need for a glass-ceramic seal as is needed in the prior art arrangement shown in FIG. 1. Eliminating the glass-ceramic seal between lower current collector 162 and fuel cell manifold 166 also limits glass-ceramic seals to being between adjacent fuel cells, and consequently, glass-ceramic seals 144 that are provided in fuel cell stack 118 are only exposed to a potential difference equal to the voltage produced by an individual fuel cell 120 which is easy for glass-ceramic seals to accommodate. Furthermore, it is possible to eliminate lower current collector 162 and utilize fuel cell manifold 166 for the same function as lower current collector 162.

While fuel cell manifold 166 has been described as a structural base upon which fuel cell stack 118 is stacked, it should now be understood that fuel cell stack 118 may be stacked upon a base member which is not involved with manifolding gases to and from fuel cell stack 118. In this variation, dielectric barrier 170 may still be utilized to electrically isolate fuel cell stack 118 from the base member, however, seals 182 may be omitted due to the lack of gas flow between the base member and fuel cell stack 118. Furthermore, fuel cell manifold 166 could be involved with transmission of less than the fuel, oxidizing agent, anode exhaust, and cathode exhaust. For example, the fuel cell stack may be an “open cathode” design where the cathodes are open to the environment. In this example the fuel cell manifold may communicate only fuel to the fuel cell stack and anode exhaust away from the fuel cell stack. Similarly, while fuel cell manifold 166 has been described as being attached to system manifold 168, it should now be understood that system manifold 168 may be involved with transmission of less than the fuel, oxidizing agent, anode exhaust, and cathode exhaust. Consequently, system manifold 168 may be generically referred to as an attachment member.

As described herein, fuel cells 120 may be high-temperature fuel cells and may more particularly be solid oxide fuel cells based on the material selected for electrolyte layer 124. While high-temperature fuel cells may use glass-ceramic seals 144 to seal between adjacent fuel cell cassettes 116, it should now be understood that dielectric barrier 170 is not limited to use in high-temperature fuel cells which utilize glass-ceramic seals to seal between adjacent fuel cell cassettes. For example, dielectric barrier 170 may also be utilized in low-temperature fuel cells such as PEM fuel cells.

While this invention has been described in terms of preferred embodiments thereof, it is not intended to be so limited, but rather only to the extent set forth in the claims that follow.

We claim:

1. A fuel cell system comprising:
a fuel cell stack assembly comprising:
a plurality of fuel cells which convert chemical energy from a fuel into electricity through a chemical reaction with an oxidizing agent, said plurality of fuel cells being stacked together in electrical series;
a base member upon which said plurality of fuel cells are stacked such that said base member is in electrical communication with said plurality of fuel cells;
an attachment member fixed to said base member, said attachment member being maintained at electrical ground; and
a dielectric barrier which electrically isolates said base member from said attachment member.

2. A fuel cell system as in claim 1 wherein said dielectric barrier comprises a dielectric member disposed between said base member and said attachment member such that said dielectric member spaces said base member from said attachment member.

3. A fuel cell system as in claim 2 further comprising a fastener which clamps said base member and said attachment member together in a clamping direction wherein said dielectric barrier further comprises an insulating washer which is clamped between said fastener and one of said base member and said attachment member in said clamping direction such that said insulating washer prevents said fastener from providing an electrically conductive path between said base member and said attachment member.

4. A fuel cell system as in claim 3 wherein said insulating washer is made of mica.

5. A fuel cell system as in claim 3 wherein said dielectric barrier further comprises an insulating sleeve which surrounds said fastener and is located between said fastener and said base member in a direction perpendicular to said clamping direction.

6. A fuel cell system as in claim 1 wherein said base member is a fuel cell manifold which includes a fuel cell manifold anode supply passage which supplies said fuel to a plurality of anodes of said plurality of fuel cells and which includes a fuel cell manifold anode exhaust passage which collects an anode exhaust from said plurality of fuel cells.

7. A fuel cell system as in claim 6 wherein said dielectric barrier comprises a dielectric member disposed between said fuel cell manifold and said attachment member such that said dielectric member spaces said fuel cell manifold from said attachment member.

8. A fuel cell system as in claim 7 wherein:
said fuel cell stack assembly is one of a plurality of fuel cell stack assemblies such that said plurality of fuel cell stack assemblies are connected together in electrical series; and
said attachment member is a system manifold having a system manifold anode supply passage which is in fluid communication with said fuel cell manifold anode supply passage of each one of said plurality of fuel cell stack assemblies, said system manifold also having a system manifold anode exhaust passage in fluid communication with said fuel cell manifold anode exhaust passage of each one of said plurality of fuel cell stack assemblies.

9. A fuel cell system as in claim 8 wherein said dielectric member includes a dielectric passage therethrough which provides fluid communication between said system manifold anode supply passage and said fuel cell manifold anode supply passage or between said system manifold anode exhaust passage and said fuel cell manifold anode exhaust passage.

10. A fuel cell system as in claim 9 further comprising a seal within said dielectric passage which provides a gas-tight seal between said fuel cell manifold and said system manifold.

11. A fuel cell system as in claim 10 wherein said seal is held in compression between said fuel cell manifold and said system manifold and is electrically insulative.

12. A fuel cell system as in claim 8 wherein each one of said plurality of fuel cell stack assemblies further comprises a fastener which clamps said fuel cell manifold to said system manifold in a clamping direction wherein said dielectric barrier further comprises an insulating washer which is clamped between said fastener and one of said fuel cell manifold in said clamping direction and said system manifold such that said insulating washer prevents said fastener from providing an electrically conductive path between said fuel cell manifold and said system manifold.

13. A fuel cell system as in claim 12 wherein said insulating washer is made of mica.

14. A fuel cell system as in claim 12 wherein said dielectric barrier further comprises an insulating sleeve which surrounds said fastener and is located between said fastener and said fuel cell manifold in a direction perpendicular to said clamping direction.

15. A fuel cell system as in claim 8 wherein:
said dielectric member is a first dielectric member; and
said dielectric barrier further comprise a second dielectric member disposed between said fuel cell manifold of one of said plurality of fuel cell stack assemblies and said fuel cell manifold of another one of said plurality of fuel cell stack assemblies such that said dielectric barrier electrically insulates said fuel cell manifold of said one of said plurality of fuel cell stack assemblies from said fuel cell manifold of said another one of said plurality of fuel cell stack assemblies.

16. A fuel cell system as in claim 6 wherein said fuel cell manifold also includes a fuel cell manifold cathode supply passage which supplies said oxidizing agent to a plurality of cathodes of said plurality of fuel cells and which includes a fuel cell manifold cathode exhaust passage which collects a cathode exhaust from said plurality of fuel cells.

17. A fuel cell system as in claim 16 wherein said dielectric barrier comprises a dielectric member disposed between said fuel cell manifold and said attachment member such that said dielectric member spaces said fuel cell manifold from said attachment member.

18. A fuel cell system as in claim 17 wherein:
said fuel cell stack assembly is one of a plurality of fuel cell stack assemblies such that said plurality of fuel cell stack assemblies are connected together in electrical series; and
said attachment member is a system manifold having a system manifold anode supply passage which is in fluid communication with said fuel cell manifold anode supply passage of each one of said plurality of fuel cell stack assemblies, a system manifold anode exhaust passage in fluid communication with said fuel cell manifold anode exhaust passage of each one of said plurality of fuel cell stack assemblies, a system manifold cathode supply passage which is in fluid communication with said fuel cell manifold cathode supply passage of each one of said plurality of fuel cell stack assemblies, and a system manifold cathode exhaust passage which is in fluid communication with said fuel cell manifold cathode exhaust passage of each one of said plurality of fuel cell stack assemblies.

19. A fuel cell system as in claim 18 wherein said dielectric member includes a dielectric passage therethrough which provides fluid communication between said system manifold anode supply passage and said fuel cell manifold anode supply passage, between said system manifold anode exhaust passage and said fuel cell manifold anode exhaust passage, between said system manifold cathode supply passage and said fuel cell manifold cathode supply passage, or between said system manifold cathode exhaust passage and said fuel cell manifold cathode exhaust passage.

20. A fuel cell system as in claim 19 further comprising a seal within said dielectric passage which provides a gas-tight seal between said fuel cell manifold and said system manifold.

21. A fuel cell system as in claim 20 wherein said seal is held in compression between said fuel cell manifold and said system manifold and is electrically insulative.

22. A fuel cell system as in claim 18 wherein each one of said plurality of fuel cell stack assemblies further comprises a fastener which clamps said fuel cell manifold to said system manifold in a clamping direction wherein said dielectric barrier further comprises an insulating washer which is clamped between said fastener and one of said fuel cell manifold and said system manifold in said clamping direction such that said insulating washer prevents said fastener from providing an electrically conductive path between said fuel cell manifold and said system manifold.

23. A fuel cell system as in claim 22 wherein said insulating washer is made of mica.

24. A fuel cell system as in claim 22 wherein said dielectric barrier further comprises an insulating sleeve which surrounds said fastener and is located between said fastener and said fuel cell manifold in a direction perpendicular to said clamping direction.

25. A fuel cell system as in claim 18 wherein:
said dielectric member is a first dielectric member; and
said dielectric barrier further comprise a second dielectric member disposed between said fuel cell manifold of one of said plurality of fuel cell stack assemblies and said fuel cell manifold of another one of said plurality of fuel cell stack assemblies such that said dielectric barrier electrically insulates said fuel cell manifold of said one of said plurality of fuel cell stack assemblies from said fuel cell manifold of said another one of said plurality of fuel cell stack assemblies.

26. A fuel cell system as in claim 1 wherein said plurality of fuel cells are held in compression by said base member and an end cap.
